(19) United States
(12) Patent Application Publication
(10) Pub. No.: US 2013/0148101 A1
(43) Pub. Date: Jun. 13, 2013

(54) TECHNIQUE FOR DISPLAYING SHAPE OF ROAD SURFACE AND METHOD THEREOF

(71) Applicants: Kyung Ho Yoo, Hwaseong (KR); Hui Sung Lee, Hwaseong (KR); Hyun Jae Yoo, Seoul (KR)

(72) Inventors: Kyung Ho Yoo, Hwaseong (KR); Hui Sung Lee, Hwaseong (KR); Hyun Jae Yoo, Seoul (KR)

(73) Assignee: HYUNDAI MOTOR COMPANY, Seoul (KR)

(21) Appl. No.: 13/470,786

(22) Filed: May 14, 2012

(30) Foreign Application Priority Data
Dec. 12, 2011 (KR) 10-2011-0133157

(51) Int. Cl. G01C 3/08

(52) U.S. Cl. 356/5.01

(57) ABSTRACT

Disclosed is a technique for displaying a shape of a road surface in front of a vehicle. The technique includes a beam emitter that emits one or more beams onto a predetermined layer toward a road surface in front of a vehicle. A beam receiver receives the one or more beams reflected from each layer after emitting the beams from the beam emitter, and a distance calculator calculates the distance to each layer respectively based on the amount of time that it takes for the one or more beams emitted from the beam emitter to be reflected. A shape determinator determines the shape of the road surface using a relationship between the distances of each layer and a display unit displays the shape of the road surface accordingly.

### CROSS-REFERENCES TO RELATED APPLICATIONS

Priority to Korean patent application number 10-2011-0133157, filed on Dec. 12, 2011, which is incorporated by reference in its entirety, is claimed.

### BACKGROUND OF THE INVENTION

1. Field of the Invention

The present invention relates to a technique for displaying a shape of a road surface.

2. Description of the Related Art

It is becoming more and more common for speed bumps to be installed on roads near a school or a residential areas to prevent vehicles from speeding through the area. Speed bumps not only prevent speeding, but also secure pedestrian safety and aid in controlling on-street parking.

Speed bumps, however, are often interpreted by drivers as an obstacle which can cause damage to his car. In particular, if a driver does not notice/identify a speed bump before driving over the speed bump at a high speed, it impacts on not only the vehicle but also passengers and items in the vehicle. Therefore, a driver must continuously watch for speed bumps, pot holes or other depressions or protrusions in the road to avoid causing damage to the vehicle and discomfort to its passengers.

In particular, if the driver does not see the depressions or protrusions in the road, the driver cannot abruptly apply the brakes if they driver is being closely followed by another vehicle as this may cause a car accident. Accordingly, there is a need for a technique which can allow a driver to accurately and efficiently identify a ridge in a road surface, such as a depression or protrusion, to reduce a driving speed and avoid it beforehand.

### SUMMARY OF THE INVENTION

The present invention has been made in view of the above problems, and provides a technique for displaying a shape (depressions or protrusions) of a road surface. The illustrative embodiment of the present invention not only perceives and displays the shape of the road surface without a very complex image creation process, but also is able to distinguish a speed bump from a ridge, by calculating distances to road surfaces for each layer of a plurality of layers based on the period of time that it takes for a plurality of beams emitted onto three distinct layers (long, middle and short distances) toward a road surface in front of a vehicle to be reflected and displays the shape of the road surface using relationships between the calculated distances for each layer.

In accordance with an aspect of the present invention, an apparatus for displaying a shape of a road surface includes: a beam emitter emitting a beam onto a predetermined layer toward a forward road surface of a vehicle; a beam receiver receiving beams reflected from each layer after emitting the beams from the beam emitter; a distance calculator calculating distances of each layer based on a time it takes for the beam emitted from the beam emitter to be reflected; a shape determinator determining the shape of the road surface using a relationship between the distances of each layer; and a display unit displaying the shape of the road surface determined by the shape determinator.

In accordance with another aspect of the present invention, a method of displaying a shape of a road surface includes: emitting a beam onto a predetermined layer toward a road surface in front of a vehicle by a beam emitter; receiving beams reflected from each layer after emitting the beams from the beam emitter by a beam receiver; calculating distances to each layer based on the amount of time it takes for the beam emitted from the beam emitter to be reflected from each layer by a distance calculator; determining the shape of the road surface using a relationship between the distances of each layer by a shape determinator; and displaying the shape of the road surface determined by the shape determinator by a display unit.

### BRIEF DESCRIPTION OF THE DRAWINGS

The objects, features and advantages of the present invention will be more apparent from the following detailed description in conjunction with the accompanying drawings, in which:

FIG. 1 is a block diagram illustrating a configuration of an apparatus for displaying a shape of a road surface according to an exemplary embodiment of the present invention;

FIG. 2 is a view illustrating a process of calculating road surface lengths between layers according to another exemplary embodiment of the present invention;

FIG. 3 is a view illustrating shapes of road surfaces according to an exemplary embodiment of the present invention;

FIG. 4 is a view illustrating a shape of a road surface displayed by an apparatus for displaying a shape of a road surface according to an exemplary embodiment of the present invention; and

FIG. 5 is a flowchart illustrating a method of displaying a shape of a road surface according to an exemplary embodiment of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

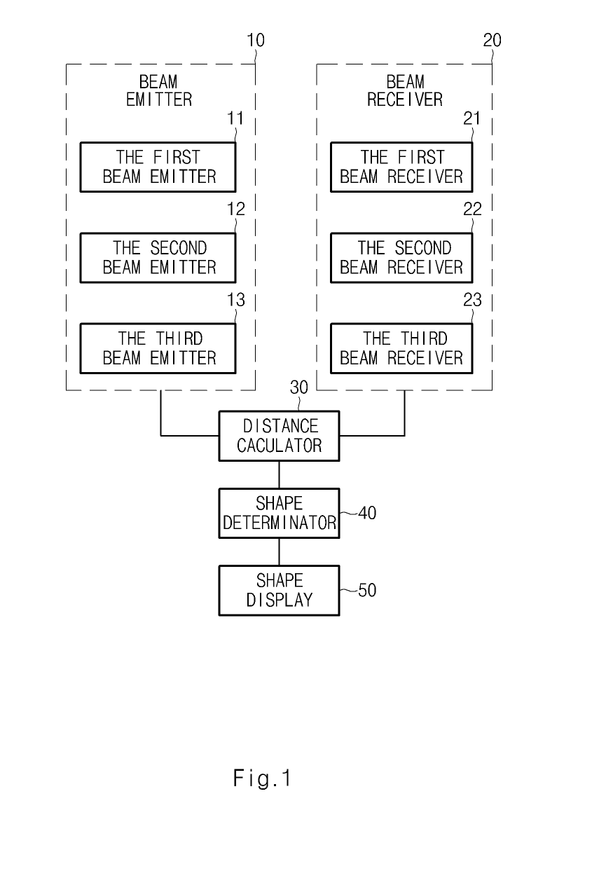

FIG. 1 is a block diagram illustrating a configuration of an apparatus for displaying a shape of a road surface according to an exemplary embodiment of the present invention. As illustrated in FIG. 1, an apparatus for displaying a shape of a road surface according to the present invention a beam emitter 10, a beam receiver 20, a distance calculator 30, a shape determinator 40, and a shape display unit 50.

Giving an overview of each structural element, the beam emitter 10 is configured to emit a beam or a plurality of beams onto at least three layers toward a road surface in front of a vehicle. That is, the beam emitter 10 emits one or more beams, such as infrared light beams, laser beams, etc., toward the road surface in front of the vehicle. More specifically, beams may be emitted in a long-distance direction (hereinafter, referred to as the first layer), in a middle-distance direction (hereinafter, referred to as the second layer), and in a short-distance direction (hereinafter, referred to as the third layer). The beam emitter 10 may include a first beam emitter 11 for emitting a beam onto the first layer, a second beam emitter 12 for emitting a beam onto the second layer, and a third beam emitter 13 for emitting a beam onto the third layer. Here, the first, second and third beam emitters 11, 12 and 13 are synchronized with one another, such that they emit beams at the same time.

Next, the beam receiver 20 may include a first beam receiver 21 for receiving the first layer beam reflected from the road surface after emitting the beam from the first beam emitter 11, a second beam receiver 21 for receiving the second layer beam reflected from the road surface after emitting the beam from the second beam emitter 12, and a third beam receiver 23 for receiving the third layer beam reflected from the road surface after emitting the beam from the third beam emitter 13.

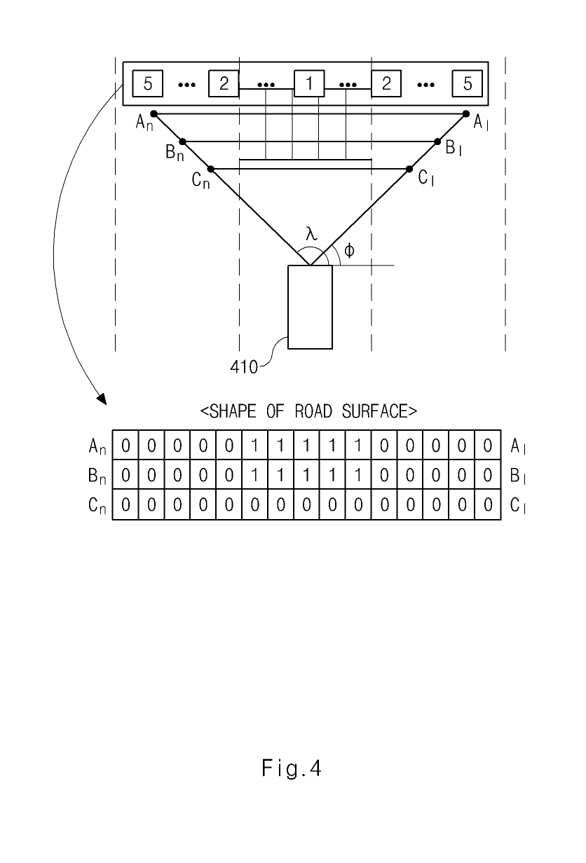

The beam emitter 10 not only emits the beams onto the three layers toward a road surface in front of a vehicle, but may also emit beams at a specific time or angular interval over a predetermined range. This will be described in detail with reference to FIG. 4.

Next, the distance calculator 30 calculates distances of each layer based on that the amount of time that it takes for the beams emitted from the beam emitter 10 to be reflected. That is, the distance calculator 30 measures amounts of times that it takes for the beams emitted from the beam emitter 10 onto the three layers to be reflected and received at the beam receiver 20, and calculates distances of the first to third layers. The distances may be calculated by multiplying the speed of light by the times.

Next, the shape determinator 40 determines the shape of the road surface using relationships between the distances of each layer calculated by the distance calculator 30. That is, the shape determinator 40 determines the shape of the road surface by calculating relationships between the distances of the second and third layers, and the distances of the first and second layers with reference to the distance of the third layer. The shape determinator may be implemented as part of a processor or control unit installed within the vehicle.

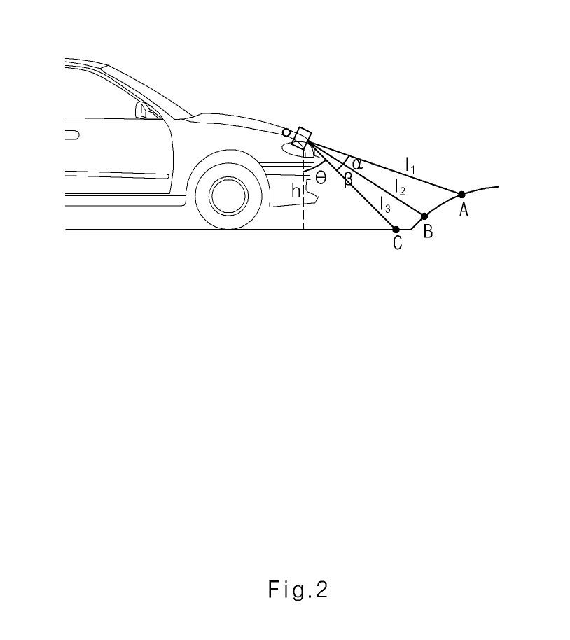

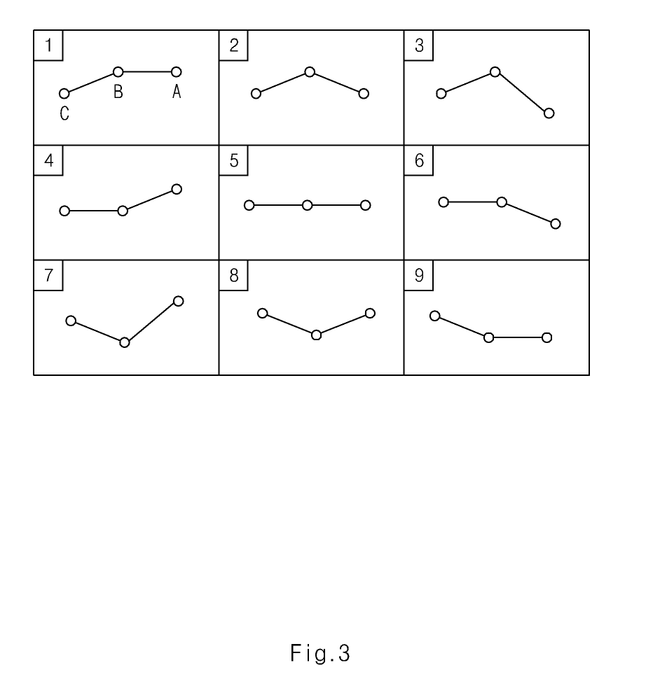

Hereinafter, operations of the shape determinator 40 will be described in detail with reference to FIGS. 2 and 3. FIG. 2 is a view illustrating a process of calculating road surface lengths between layers according to another exemplary embodiment of the present invention. As illustrated in FIG. 2, ‘A’ denotes the first layer, ‘B’ denotes the second layer, and ‘C’ denotes the third layer. ‘l₁’ denotes a distance of the first layer, ‘l₂’ denotes a distance of the second layer, and ‘l₃’ denotes a distance of the third layer.

Further, ‘α’ denotes an angle between the first and second layers, ‘β’ denotes an angle between the second and third layers, and ‘θ’ denotes an angle between a line perpendicular to the ground and the third layer.

The ideal condition of a level road is expressed by following Equation 1.

A̅C̅= A̅B̅+ B̅C̅ [Equation 1]

However, in a actual driving environment, there is almost no case that satisfies the conditions of Equation 1. Therefore, it is determined that a road surface is flat when satisfying following Equation 2.

| A̅C̅−( A̅B̅+ B̅C̅)|<ε, [Equation 2]

where ‘ε’ is a threshold.

The lengths of a road surface between layers are expressed by following Equation 3.

A̅B̅=\sqrt{l₁²+l₂²−2·l₁·l₂ cos α}

B̅C̅=\sqrt{l₂²+l₃²·2·l₂·l₃ cos β}

A̅C̅=\sqrt{l₁²+l₃²−2·l₃ cos(α÷β)} [Equation 3]

When Equation 3 is varied into relationship equations between ‘l₁’ and ‘l₂, ‘l₂’ and ‘l₃’, and ‘l₁’ and ‘l₂, it is expressed by following Equation 4 and

### Equation 5.

$$\begin{matrix}{l}_{2} = \frac{h}{cos ( θ \div β )} \\ \begin{matrix}{l}_{1} = \frac{h}{cos ( θ \div β \div α )} \\ = \frac{h}{cos α cos ( θ \div β ) - sin α sin ( θ \div β )} \\ = \frac{\frac{h}{cos ( θ \div β )}}{cos ( α ) - sin ( α ) tan ( θ \div β )}\end{matrix} \\ ∴ {l}_{1} = \frac{{l}_{2}}{cos ( α ) - sin ( α ) tan ( θ \div β )} & [ Equation 4 ] \\ {l}_{2} = \frac{{l}_{3}}{cos ( β ) - tan ( θ ) sin ( β )} \\ {l}_{1} = \frac{{l}_{3}}{cos ( α + β ) - tan ( θ ) sin ( α + β )} & [ Equation 5 ]\end{matrix}$$

A shape of a road surface is determined using Equation 5 and Equation 6 will be described below with reference to FIG. 3. In FIG. 3, the shape of number 1 satisfies following Equation 6.

$${l}_{2} < \frac{{l}_{3}}{cos ( β ) - tan ( θ ) sin ( β )} \& \\ {l}_{1} = \frac{{l}_{2}}{cos ( α ) - sin ( α ) tan ( θ + β )} \& \\ {l}_{1} < \frac{{l}_{3}}{cos ( α + β ) - tan ( θ ) sin ( α + β )} \qquad [ Equation 6 ]$$

where ‘&’ means a condition of satisfying all three equations.

The shape of number 2 satisfies following Equation 7.

$${l}_{2} < \frac{{l}_{3}}{cos ( β ) - tan ( θ ) sin ( β )} \& \\ {l}_{1} > \frac{{l}_{2}}{cos ( α ) - sin ( α ) tan ( θ + β )} \& \\ {l}_{1} = \frac{{l}_{3}}{cos ( α + β ) - tan ( θ ) sin ( α + β )} \qquad [ Equation 7 ]$$

The shape of number 3 satisfies following Equation 8.

$${l}_{2} < \frac{{l}_{3}}{cos ( β ) - tan ( θ ) sin ( β )} \& \\ {l}_{1} > \frac{{l}_{2}}{cos ( α ) - sin ( α ) tan ( θ + β )} \& \\ {l}_{1} > \frac{{l}_{3}}{cos ( α + β ) - tan ( θ ) sin ( α + β )} \qquad [ Equation 8 ]$$

The shape of number 4 satisfies following Equation 9.

$${l}_{2} = \frac{{l}_{3}}{cos ( β ) - tan ( θ ) sin ( β )} \& \\ {l}_{1} < \frac{{l}_{2}}{cos ( α ) - sin ( α ) tan ( θ + β )} \& \\ {l}_{1} < \frac{{l}_{3}}{cos ( α + β ) - tan ( θ ) sin ( α + β )} \qquad [ Equation 9 ]$$

The shape of number 5 satisfies following Equation 10.

$${l}_{2} = \frac{{l}_{3}}{cos ( β ) - tan ( θ ) sin ( β )} \& \\ {l}_{1} = \frac{{l}_{2}}{cos ( α ) - sin ( α ) tan ( θ + β )} \& \\ {l}_{1} = \frac{{l}_{3}}{cos ( α + β ) - tan ( θ ) sin ( α + β )} \qquad [ Equation 10 ]$$

The shape of number 6 satisfies following Equation 11.

$${l}_{2} = \frac{{l}_{3}}{cos ( β ) - tan ( θ ) sin ( β )} \& \\ {l}_{1} > \frac{{l}_{2}}{cos ( α ) - sin ( α ) tan ( θ + β )} \& \\ {l}_{1} > \frac{{l}_{3}}{cos ( α + β ) - tan ( θ ) sin ( α + β )} \qquad [ Equation 11 ]$$

The shape of number 7 satisfies following Equation 12.

$${l}_{2} > \frac{{l}_{3}}{cos ( β ) - tan ( θ ) sin ( β )} \& \\ {l}_{1} < \frac{{l}_{2}}{cos ( α ) - sin ( α ) tan ( θ + β )} \& \\ {l}_{1} < \frac{{l}_{3}}{cos ( α + β ) - tan ( θ ) sin ( α + β )} \qquad [ Equation 12 ]$$

The shape of number 8 satisfies following Equation 13.

$${l}_{2} > \frac{{l}_{3}}{cos ( β ) - tan ( θ ) sin ( β )} \& \\ {l}_{1} < \frac{{l}_{2}}{cos ( α ) - sin ( α ) tan ( θ + β )} \& \\ {l}_{1} = \frac{{l}_{3}}{cos ( α + β ) - tan ( θ ) sin ( α + β )} \qquad [ Equation 13 ]$$

The shape of number 9 satisfies following Equation 14.

$${l}_{2} > \frac{{l}_{3}}{cos ( β ) - tan ( θ ) sin ( β )} \& \\ {l}_{1} = \frac{{l}_{2}}{cos ( α ) - sin ( α ) tan ( θ + β )} \& \\ {l}_{1} > \frac{{l}_{3}}{cos ( α + β ) - tan ( θ ) sin ( α + β )} \qquad [ Equation 14 ]$$

The shape determinator 40 determines a shape of a road surface using relationship equations between ‘l₁’ and ‘l₂, ‘l₂’ and ‘l₃’, and ‘l₁’ and ‘l₂, such as Equations 6 through 14.

The display unit 50 displays the shape of the road surface determined by the shape determinator 40 accordingly. That is, the shape display 50 displays ‘1’ when it is shorter than ‘l₃’ as a reference (0) and ‘−1’ when it is longer than ‘l₃’.

Hereinafter, the display unit 50 according to the present invention will be described in detail with reference to FIG. 4. FIG. 4 is a view illustrating a shape of a road surface displayed by an apparatus for displaying a shape of a road surface according to another exemplary embodiment of the present invention. As illustrated in FIG. 4, a sensor 410 including the beam emitter 10 and the beam receiver 20 not only emits beams onto the three layers (A, B and C) toward a forward road surface of a vehicle at the same time, but also emits beams n times (A₁˜Aₙ, B₁˜Bₙ, C₁˜Cₙ) at a predetermined time interval and a predetermined angle interval in a predetermined range (λ-φ). The n (natural number) satisfies the following Equation 15.

λ=φ+(n×ω), [Equation 15]

where φ denotes an angle of a start point (A₁, B₁, C₁) of a range of emitting a beam, X denotes an angle of an end point (Aₙ, Bₙ, Cₙ) of the range of emitting the beam, and w denotes an angle interval (for example, 0.1 degree). FIG. 4 shows a shape of a road surface when the shape of number 1 in FIG. 3 is detected five times in a horizontal direction.

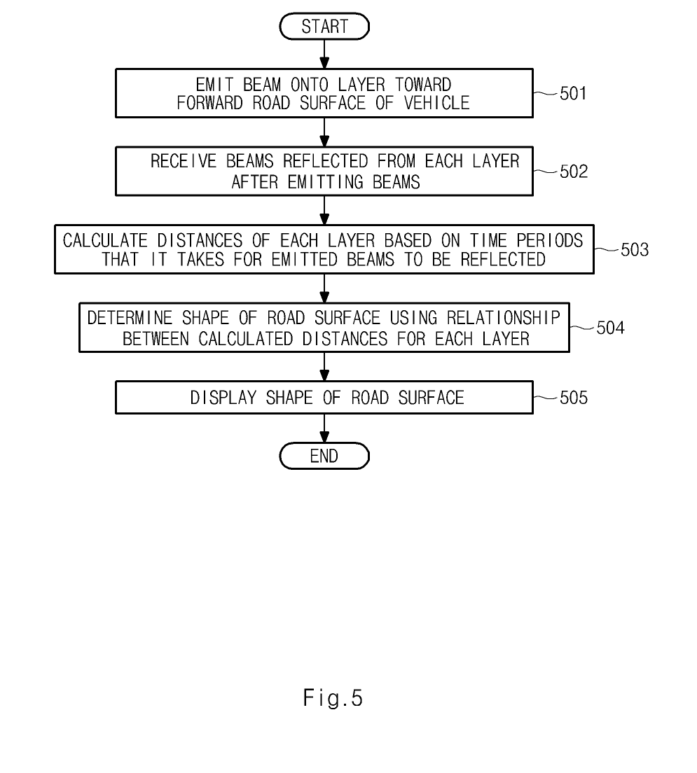

FIG. 5 is a flowchart illustrating a method of displaying a shape of a road surface according to another exemplary embodiment of the present invention. First, the beam emitter 10 emits one or more beams onto a predetermined layer toward a road surface in front of a vehicle (501). Then, the beam receiver 20 receives one or more beams reflected from each layer after emitting the beams from the beam emitter 10 (502). Then, the distance calculator 30 calculates distances to each layer based on that the amount of time it takes for each of the respective beams emitted from the beam emitter 10 to be reflected (503). Then, the shape determinator 40 determines the shape of the road surface using a relationship between the distances of each layer calculated by the distance calculator 30 (504). Then, the shape display 50 displays the shape of the road surface determined by the shape determinator (505).

Through those operations, it is possible to perceive and display the shape of the road surface without a an overly complex image creation process, and distinguish a speed bump from a ridge.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Advantageously, the present invention is able to perceive and display the shape of the road surface without an overly complex image creation process, by calculating distance to road surfaces over a plurality of layers based on the amount of time it takes for each of the one or more beams emitted onto three layers (i.e., long, middle and short distances) toward a road surface in front of a vehicle to be reflected and displaying the shape of the road surface using relationships between the calculated distances for each layer.

Furthermore, the present invention is able to distinguish a speed bump from a ridge, by calculating the respective distance to road surfaces for each layer based on the time it takes for beams emitted onto three layers (long, middle and short distances) toward a road surface in front of a vehicle to be reflected and displaying the shape of the road surface using relationships between the calculated distances for each layer.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. An apparatus for displaying a shape of a road surface, the apparatus comprising:
a beam emitter configured to emit one or more beams onto a predetermined layer on a road surface in front of a vehicle;
a beam receiver configured to receive beams reflected from each layer of a plurality of layers after emitting the one or more beams from the beam emitter;
a distance calculator is configured to calculate a distance to each layer based on an amount of time it takes for the one or more beams emitted from the beam emitter to be reflected;
a shape determinator configured to determine the shape of the road surface using a relationship between the distance to each layer; and
a display unit configured to display the shape of the road surface determined by the shape determinator.

2. The apparatus of claim 1, wherein the beam emitter emits one or more beams onto a first layer in a long-distance direction, a second layer in a middle-distance direction, and a third layer in a short-distance direction, toward the forward road surface, respectively.

3. The apparatus of claim 2, wherein the beam emitter comprises:
a first beam emitter configured to emit one or more beams onto the first layer;
a second beam emitter configured to emit one or more beams onto the second layer; and
a third beam emitter configured to emit one or more beams onto the third layer.

4. The apparatus of claim 3, wherein the first, second and third beam emitters emit the one or more beams at the same time.

5. The apparatus of claim 3, wherein the beam receiver comprises:
a first beam receiver configured to receive a first layer beam reflected from the road surface after emitting the beam from the first beam emitter;
a second beam receiver configured to receive a second layer beam reflected from the road surface after emitting the beam from the second beam emitter; and
a third beam receiver configured to receive a third layer beam reflected from the road surface after emitting the beam from the third beam emitter.

6. The apparatus of claim 2, wherein the shape determinator calculates relationships between distances of the first and second layers and between distances of the second and third layers with reference to the distance of the third layer to determine the shape of the road surface.

7. The apparatus of claim 6, wherein the beam emitter emits beams of ‘3 layers×n (natural number) rows’ toward the forward road surface of the vehicle.

8. The apparatus of claim 7, wherein the shape determinator determines shapes of the road surface with respect to each row having three layers.

9. The apparatus of claim 8, wherein the shape display progressively displays the shapes of the road surface with respect to each row determined by the shape determinator.

10. A method of displaying a shape of a road surface, the method comprising:
emitting one or more beams onto a predetermined layer toward a road surface in front of a vehicle by a beam emitter;
receiving the one or more beams reflected, from each layer after emitting the one or more beams from the beam emitter by a beam receiver;
calculating a distance of each layer based on an amount of time that it takes for the one or more beams emitted from the beam emitter to be reflected by a distance calculator;
determining the shape of the road surface using a relationship between the distances to each layer by a shape determinator; and
displaying the shape of the road surface determined by the shape determinator by a display unit.

11. The method of claim 10, wherein emitting one or more beams onto the predetermined layer toward the road surface in front of the vehicle by the beam emitter further comprises emitting beams onto a first layer in a long-distance direction, a second layer in a middle-distance direction, and a third layer in a short-distance direction, toward the forward road surface, respectively.

12. The method of claim 11, wherein emitting the one or more beams onto the predetermined layer toward the road surface in front of the vehicle by the beam emitter further comprises emitting the one or more beams at the same time.

13. The method of claim 10, wherein determining the shape of the road surface using a relationship between the distances to each layer by a shape determinator further comprises calculating relationships between distances to the first and second layers and between distances of the second and third layers with reference to the distance of the third layer to determine the shape of the road surface.

14. The method of claim 13, wherein emitting a beam onto a predetermined layer toward a forward road surface of a vehicle by a beam emitter emits beams of ‘3 layers×n (natural number) rows’ toward the forward road surface of the vehicle.

15. The method of claim 14, wherein determining the shape of the road surface using a relationship between the distances of each layer by the shape determinator further comprises determining shapes of the road surface with respect to each row having three layers.

16. The method of claim 15, wherein determining the shape of the road surface using the relationship between the distances to each layer by the shape determinator further comprises progressively displaying the shapes of the road surface with respect to each row determined by the shape determinator.

17. A non-transitory computer readable medium containing program instructions executed by a processor or controller, the computer readable medium comprising:
program instructions that control a beam emitter to emit one or more beams onto a predetermined layer toward a road surface in front of a vehicle by a beam emitter;
program instructions that calculate a distance of each layer based on an amount of time that it takes for the one or more beams emitted from the beam emitter to be reflected;
program instructions that determine the shape of the road surface using a relationship between the distances to each; and
program instructions that display the shape of the road surface on a display unit.
